(19) United States
(12) Patent Application Publication
(10) Pub. No.: US 2007/0068290 A1
(43) Pub. Date: Mar. 29, 2007

(54) Step motor-based linear actuator

(75) Inventor: T.C. Huang, Changhua County (TW)

Correspondence Address: BACON & THOMAS, PLLC, 625 SLATERS LANE, FOURTH FLOOR, ALEXANDRIA, VA, 22314, US

(73) Assignee: TRICORE CORPORATION, Chang Hua (TW)

(21) Appl. No.: 11/515,814

(22) Filed: Sep. 6, 2006

(30) Foreign Application Priority Data
Sep. 16, 2005 (TW) 94216039

(51) Int. Cl. F16H 25/20

(52) U.S. Cl. 74/89.23

(57) ABSTRACT

A motor-based linear actuator includes a coil assembly housed in a housing and holding two coils, a driving assembly surrounded by the coils and rotatable by the magnetic force induced upon connection of electric current to the coils, a linear guider fixedly, which is fastened to the housing and defines therein a sliding hole and a plurality of sliding grooves in the sliding hole, and an actuating assembly inserted through the sliding hole and coupled to the sliding grooves and threaded onto a front screw rod of the driving assembly for reciprocating motion along the sliding grooves during forward/backward rotation of the driving assembly.

### BACKGROUND OF THE INVENTION

1. Field of the Invention

The present invention relates to linear actuators and more particularly, to a step motor-based linear actuator.

2. Description of the Related Art

A step motor may be used to convert a rotary driving force into a linear driving force, achieving the action of an electromagnetic valve. Comparing to an electromagnetic valve, a step motor has the advantage of multi-position controllable characteristic. However, conventional converting means that converts the rotary motion of a step motor into a linear motion commonly has a complicated structure. Further, it cannot eliminate energy loss during operation.

Therefore, it is desirable to provide a linear actuator that eliminates the aforesaid problems.

### SUMMARY OF THE INVENTION

The present invention has been accomplished under the circumstances in view. It is one object of the present invention to provide a step motor-based linear actuator, which converts the rotary motion of a step motor into a linear motion. It is another object of the present invention to provide a step motor-based linear actuator, which has a simple structure that is easy to assemble and that works accurately.

To achieve these and other objects of the present invention, the step motor-based linear actuator comprises a coil assembly, the coil assembly comprising a holder base, a receptacle fixedly provided at one side of the holder base for connection to power supply, and at least one coil mounted inside the holder base and electrically connected to the receptacle; a driving assembly, the driving assembly comprising a shaft, a magnetic member mounted on the shaft, and a screw rod axially connected to one end of the shaft, the screw rod having a threaded shank extending out of the shaft; a linear guider, the linear guider having a body, the body of the linear guider having a sliding hole cut through front and back sides thereof and at least one sliding groove axially disposed in the sliding hole; an actuating assembly, the actuating assembly comprising a post axially slidably inserted into the sliding hole of the linear guider, the post having at least one sliding block respectively slidably coupled to the at least one longitudinal sliding groove of the linear guider, and a screw hole threaded onto the threaded shank of the screw rod of the driving assembly.

### BRIEF DESCRIPTION OF THE DRAWINGS

FIG. 1 is an elevational view of a step motor-based linear actuator according to the present invention.

FIG. 2 is a sectional front view in an enlarged scale of the step motor-based linear actuator according to the present invention.

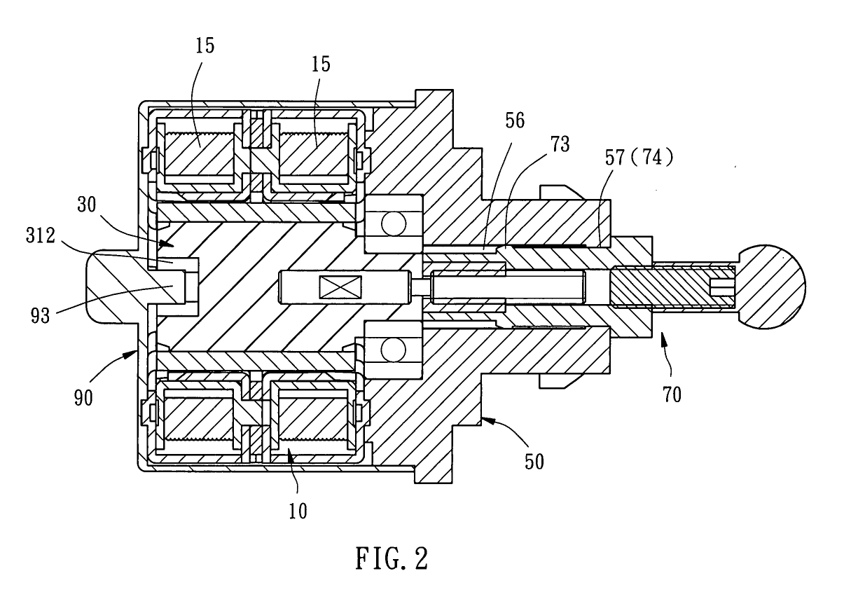

FIG. 3 is a sectional top view in an enlarged scale of the step motor-based linear actuator according to the present invention.

FIG. 4 is similar to FIG. 3 but showing the actuating assembly extended out.

FIG. 5 is an oblique view in an enlarged scale of a part of FIG. 1.

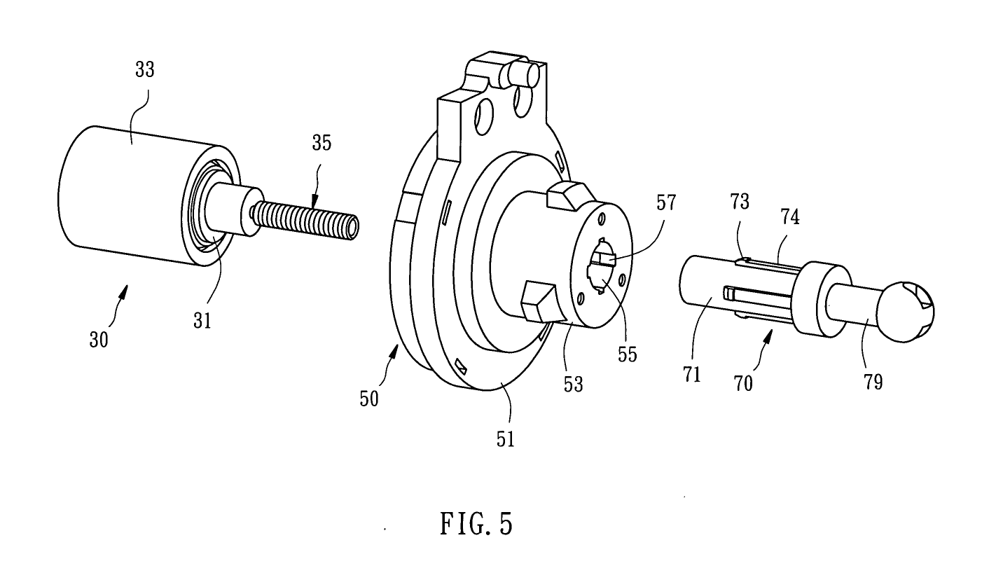

FIG. 6 is a side view in section of FIG. 5.

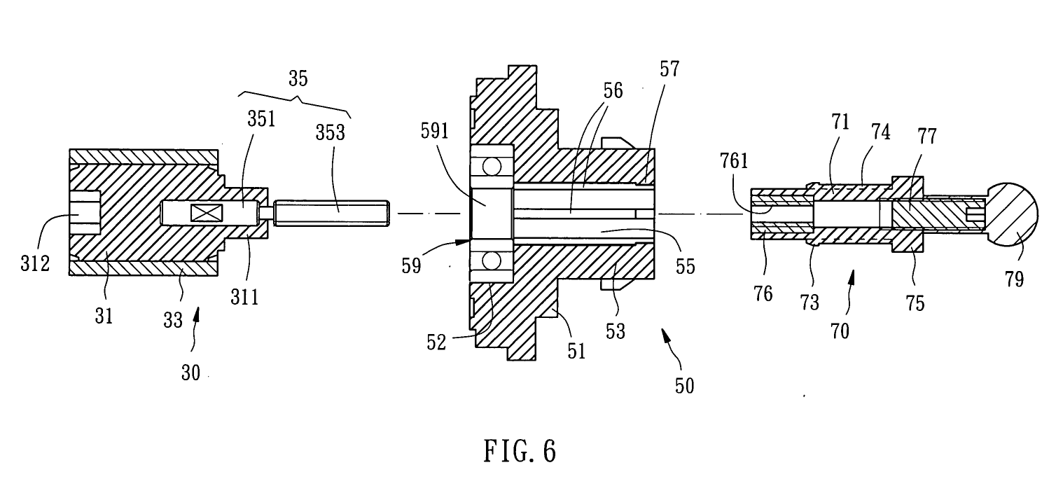

### DETAILED DESCRIPTION OF THE INVENTION

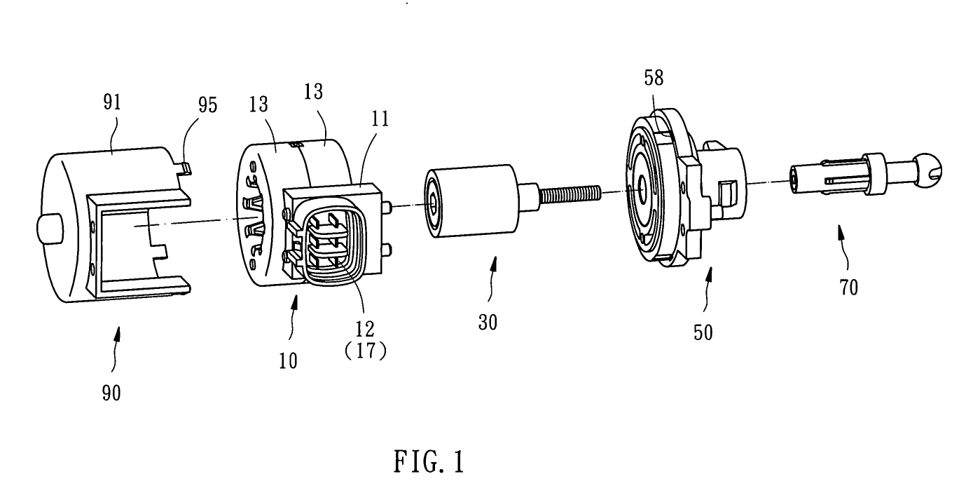

Referring to FIGS. 1˜6, a step motor-based linear actuator in accordance with the present invention is shown comprised of a coil assembly 10, a driving assembly 30, a linear guider 50, an actuating assembly 70, and a housing 90.

The coil assembly 10 comprises a holder base 11, a receptacle 12 fixedly provided at one side of the holder base 11, two ratchet barrels 13 fixedly provided at one side of the holder base 11 opposite to the receptacle 12, two coils 15 respectively mounted inside the ratchet barrels 13, and a plurality of terminals 17 installed in the receptacle 12 and respectively connected to the coils 15.

The driving assembly 30 comprises a shaft 31, which has an axle bearing portion 311 and a rear mounting hole 312, a magnetic bushing 33 mounted on the shaft 31, and a screw rod 35, which has a rear mounting portion 351 embedded in the front mounting portion 311 of the shaft 31 and a threaded shank 353 axially forwardly extending from the rear mounting portion 351.

The linear guider 50 comprises a body 51 and an axle bearing 59. The body 51 has an axle bearing mounting hole 52 at the back side, a forwardly extending front extension 53, a sliding hole 55 axially extending through the front extension 53 in communication with the axle bearing mounting hole 52, four longitudinal sliding grooves 56 equiangularly spaced around the sliding hole 55 and respectively terminating in a respective locating slot 57, and a plurality of hook holes 58 spaced around the periphery. The axle bearing 59 is mounted in the axle bearing mounting hole 52 of the body 51, the axle bearing 59 has a rear axle bearing hole 591 providing support of the axle bearing portion 311 of the driving assembly 30, the rear axle bearing hole 591 is coaxial with the sliding hole 55.

The actuating assembly 70 comprises a post 71, a screw member 76, and an extension rod 77, and a connector 79. The post 71 is inserted into the sliding hole 55 of the body 51 of the linear guider 50, having a head 75 extending around the periphery at one end, four longitudinal ribs 74 respectively connected to the head 75 and equiangularly spaced around the periphery and respectively supported on the locating slots 57 in the body 51 of the linear guider 50, and four sliding blocks 73 respectively formed integral with one end of each of the longitudinal ribs 74 remote from the head 75 and slidably coupled to the longitudinal sliding grooves 56 of the body 51 of the linear guider 50. When moving the post 71 outwards relative to the linear guider 50, the sliding blocks 73 will be stopped at the stepped junction between each longitudinal sliding groove 56 and the respective locating slot 57. The screw member 76 is fixedly mounted in the post 71, having a rear screw hole 761 threaded onto the threaded shank 353 of the screw rod 35 of the driving assembly 30. The extension rod 77 is fixedly connected to screw member 76 and extending out of the head 75 of the post 71. The connector 79 is fixedly fastened to one end of the extension rod 77 outside the post 71.

The housing 90 has a body 91 that covers the ratchet barrels 13 of the coil assembly 10, an inside plug 93 fitted into the rear mounting hole 312 of the shaft 31 of the driving assembly 30, and a plurality of hooks 95 respectively hooked in the hook holes 58 of the linear guider 50.

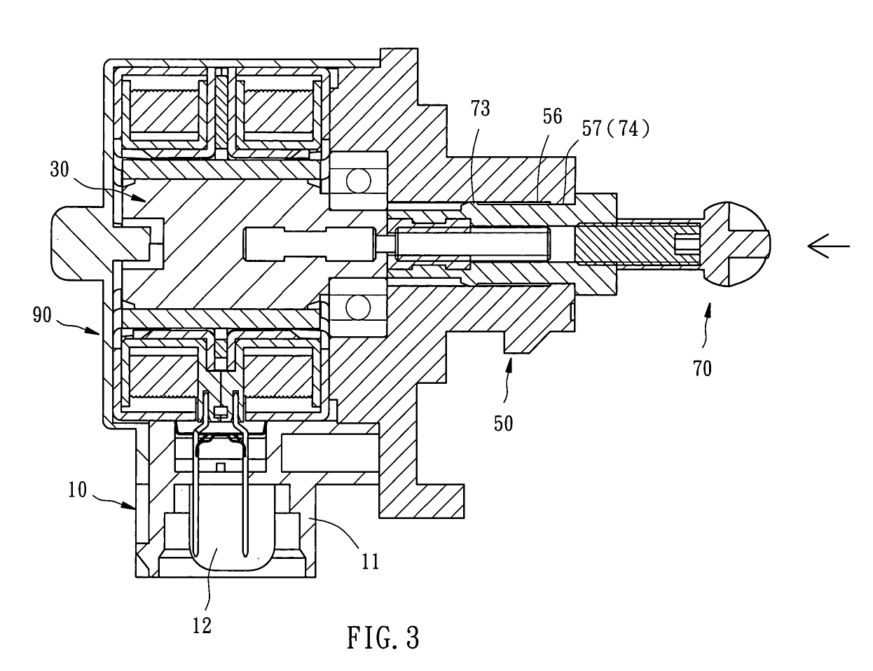

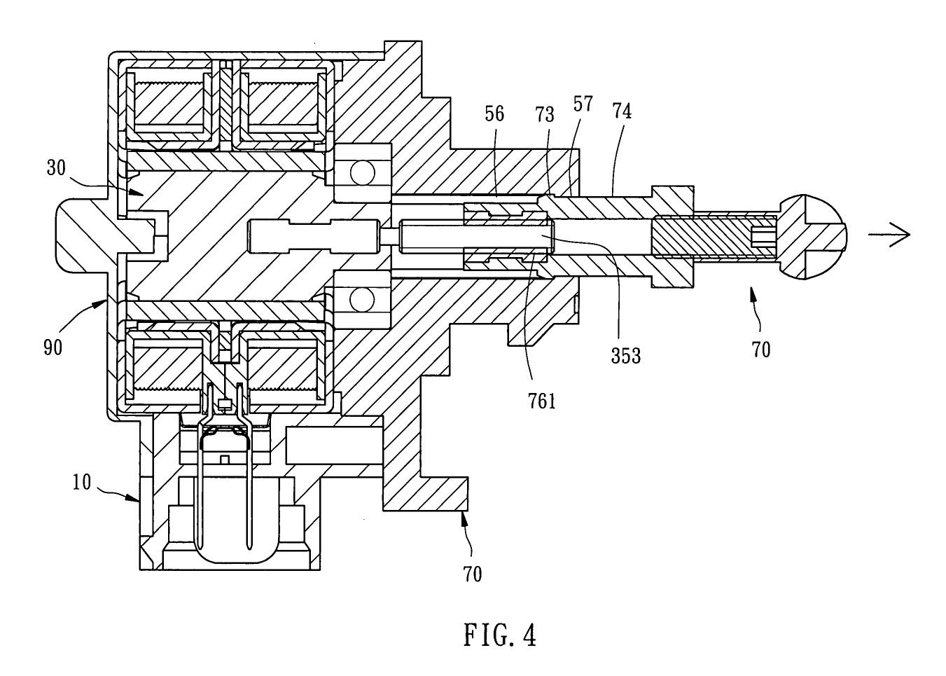

When in use, as shown in FIG. 3, electric current is connected to the coils 15 through the terminals 17 installed in the receptacle 12, causing the coils 15 to produce a magnetic field that acts against the driving assembly 30, and therefore the screw rod 35 is rotated with the shaft 31 and the threaded shank 353 threading onto the rear screw hole 761 of the actuating assembly 70. Because the sliding blocks 73 and longitudinal ribs 74 of the actuating assembly 70 are respectively slidably coupled to the longitudinal sliding grooves 56 and locating slots 57 of the body 51 of the linear guider 50, rotation of the screw rod 35 causes the actuating assembly 70 to move axially in the sliding hole 55 of the linear guider 50 (see FIG. 4).

On the contrary, by means of revering the electric current to the coils 15 of the coil assembly 10, the actuating assembly 70 is moved axially in the sliding hole 55 of the linear guider 50 in the reversed direction (see FIG. 3).

Further, the motor that is formed of the coil assembly 10 and the driving assembly 30 according to the present invention is a step motor that can control forward/backward rotation of the driving assembly 30 and the number of runs of the rotation, driving the actuating assembly 70 to achieve different actions.

Moreover, the shaft 31 of the driving assembly 30 may be made of same material and formed integral with the magnetic bushing 33 or the screw rod 35 to save the assembly work and cost.

As indicated above, the step motor-based linear actuator has the following benefits:

1. The step motor-based linear actuator effectively converts the rotary motion of a step motor into a linear motion.

2. The step motor-based linear actuator has a simple structure that is easy to assemble and that works accurately.

What is claimed is:

1. A step motor-based linear actuator comprising:
a coil assembly, said coil assembly comprising a holder base, a receptacle fixedly provided at one side of said holder base for connection to power supply, and a coil mounted inside said holder base and electrically connected to said receptacle;
a driving assembly, said driving assembly comprising a shaft, a magnetic member mounted on said shaft, and a screw rod axially connected to one end of said shaft, said screw rod having a threaded shank extending out of said shaft;
a linear guider, said linear guider having a body, the body of said linear guider having a sliding hole cut through front and back sides thereof and at least one sliding groove axially disposed in said sliding hole;
an actuating assembly, said actuating assembly comprising a post axially slidably inserted into the sliding hole of said linear guider, said post having at least one sliding block respectively slidably coupled to the at least one longitudinal sliding groove of said linear guider, and a screw hole threaded onto the threaded shank of said screw rod of said driving assembly.

2. The step motor-based linear actuator as claimed in claim 1, wherein said coil assembly further comprises at least one ratchet barrel assembled with said holder base and adapted to hold said at least one coil.

3. The step motor-based linear actuator as claimed in claim 1, wherein said magnetic member of said driving assembly is a magnetic bushing sleeved onto said shaft.

4. The step motor-based linear actuator as claimed in claim 1, wherein said shaft of said driving assembly has an axle bearing portion coupled to said linear guider; the body of said linear guider has a rear axle bearing hole for supporting the axle bearing portion of said driving assembly.

5. The step motor-based linear actuator as claimed in claim 1, wherein said screw rod of said driving assembly has a rear mounting portion embedded in said shaft.

6. The step motor-based linear actuator as claimed in claim 1, wherein said linear guider further comprises an axle bearing mounted in the body of said linear guider for supporting said shaft of said driving assembly.

7. The step motor-based linear actuator as claimed in claim 1, wherein the body of said linear guider has a forwardly extending front extension, which defines therein said sliding hole and said at least one sliding groove.

8. The step motor-based linear actuator as claimed in claim 1, wherein said linear guider further has at least one locating slot respectively terminated on an end of said at least one sliding groove for stopping the at least one sliding block of said actuating assembly; said post of said actuating assembly has at least one longitudinal rib respectively connected to said at least one sliding block and respectively supported in said at least one locating slot.

9. The step motor-based linear actuator as claimed 1, wherein said actuating assembly further comprises a screw member mounted inside said post; the screw hole of said actuating assembly is defined in a rear end of said screw member.

10. The step motor-based linear actuator as claimed in claim 1, further comprising a housing surrounding said coil assembly.
